(19) United States
(12) Patent Application Publication
(10) Pub. No.: US 2007/0276800 A1
(43) Pub. Date: Nov. 29, 2007

(54) Method For Controlling Display Of Keyword Advertisement In Internet Search Engine And A System Thereof

(75) Inventor: Woo Sung Lee, Seoul (KR)

Correspondence Address: BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 10/599,923

(22) PCT Filed: Apr. 12, 2005
(86) PCT No.: PCT/KR05/01049

§ 371 Date: Oct. 13, 2006

(30) Foreign Application Priority Data
Apr. 14, 2004 (KR) 10-2004-0025656

(51) Int. Cl. G06Q 99/00

(52) U.S. Cl. 707/3

(57) ABSTRACT

A method for controlling display of a keyword advertisement according to the present invention comprises the steps of defining, in response to input of a keyword by a searcher, a plurality of locations where search listings are displayed on a web page, as unit display zones in association with the keyword; receiving bid data corresponding to a first unit display zone, which is one of the plurality of unit display zones associated with the predetermined keyword, from an advertiser; associating the advertiser with a predetermined search listing; receiving automatic bid data corresponding to at least one unit display zone except the first unit display zone, among the plurality of unit display zones associated with the keyword, from the advertiser; if the bid data of the advertiser are successfully bidden through a predetermined bid process for the first unit display zone, assigning a display right in the first display zone to the search listing associated with the advertiser; if a predetermined transfer condition for the assigned display right is satisfied, depriving the search listing associated with the advertiser in the first unit display zone of the display right; and if the search listing in the first unit display zone is deprived of the display right, performing a re-bid process for the input automatic bid data.

### TECHNICAL FIELD

The present invention relates to a method for controlling display of a keyword advertisement and a system thereof, and more particularly, to a method for controlling display of a keyword advertisement and a system thereof, wherein if a search listing displayed at a predetermined display location loses its right to be displayed thereat, the corresponding search listing is allowed to be successively displayed at a different display location through an automatic re-bid.

### BACKGROUND ART

Recently, information searches through a communication network are generalized with the rapid development of a communication network such as the Internet. That is, an Internet user (a searcher) can readily obtain necessary information anywhere and anytime using the Internet. Such information searches give rise to lots of changes in our entire lives.

Therefore, there have been developed and proposed a variety of models regarding an aspect of advertising fee payment between an operator who supports search services for Internet users and an advertiser who gets advertising effects through display of information on his/her information website to the Internet users using the search services.

That is, in search services through a search engine, there are a variety of aspects of advertising fee payment depending on methods for extracting information on advertisers, methods for displaying extracted information on advertisers to searchers, billing methods for displayed information on advertisers, and the like.

As an example of an aspect of advertising fee payment, there is a method in which a display location where advertiser information will be displayed on a search screen is previously selected, a selling price is estimated for each of selected display locations, and the display locations are sold at the estimated prices to advertisers. This method for selling each display location is a method in which a right to display information is assigned to an advertiser who first has paid the selling price of a specific display location at which information on any advertisers has not been displayed. However, this method has a problem in that an advertiser who wants to display information at a corresponding display location (a specific display location where information on an advertiser has already been displayed) should wait until a previous contract term of display of information on an advertiser, which is being displayed, is expired. In other words, the method for selling each display location is an aspect of advertising fee payment in which an advertiser should preoccupy a specific display location. This method is disadvantageous in that advertisers cannot display their information within contract terms during which all display locations are occupied by other advertisers. Further, since this method is a priority-based selling method, it has a problem in that display of advertiser information at a specific location cannot be guaranteed even though the advertiser waits until a contract term of another advertiser is expired. Furthermore, since the selling price of each display location is arbitrarily determined by a service operator, this method has a problem in that an advertiser's position on a corresponding selling price is not taken into consideration.

Further, as another example of an aspect of advertising fee payment, there is a method in which advertiser information is displayed and an advertising fee is determined according to a cost-per-click (CPC) scheme. That is, the CPC scheme is a method in which a keyword advertising fee is calculated by measuring the number of access connections (effective connection number) between searchers and a specific advertiser as search-requesting searchers click on information on the advertiser. Search results are provided to the searcher, wherein information on an advertiser who has presented the highest CPC price (billing fee per click) is arranged at the top and information on advertisers who have presented lower CPC prices is arranged at the bottom. The aspect of advertising fee payment according to this CPC scheme has a problem in that display of information on an advertiser at a display location desired by the advertiser cannot be guaranteed. That is, in this method, CPC prices presented by one or more advertisers are compared with one another and arranged in order, and information on the advertisers is displayed on a search screen according to the arrangement order. This method has a disadvantage in that information may be displayed at a display location that is not desired by an advertiser. Furthermore, in the CPC method, an advertiser has a tendency to display his/her (company's) search listing at the top of a screen having a good click-through rate (CTR; clicks versus display). This causes a continuous rise in costs of a keyword advertisement of advertiser information. This may also have adverse effects that cause lots of advertisers to give up advertisement due to high advertising costs.

Further, as a further example of an aspect of advertising fee payment, there is a method in which information on a bid price is received from one or more advertisers during a predetermined period in order to determine display of advertiser information at a specific display location, and a right to display advertiser information at a corresponding display location is assigned to an advertiser who presents the highest bid price. This advertising fee payment method has problems in that a bid period during which bid prices are received is needed, and advertisers' requests for rapid registration of advertising information cannot be properly accepted.

Accordingly, there is a need for the emergence of a new type advertising fee payment model in which rapid advertisement display and advertising effects can be induced in such a manner that information on an advertiser is displayed at a display location desired by the advertiser through a predetermined bid process, using costs per click of a searcher as betting data of an advertiser for participation in a bid. Furthermore, there is a need for an additional advertising fee payment model in which an advertiser can obtain successive advertising effects in such a manner that even though the advertiser is deprived of a right to display his/her information at a specific display location, the advertiser can maintain the information display at a different display location through an automatic re-bid.

### Technical Problem

The present invention is conceived to solve the aforementioned problems. An object of the present invention is to provide a method for controlling a keyword advertisement and a system thereof, wherein even though a right to display a search listing at a predetermined display location is lost under a predetermined condition, the display of the corresponding search listing continues through an automatic bid process allowing the search listing to be displayed at a different display location.

Another object of the present invention is to provide a method for controlling a keyword advertisement and a system thereof, wherein advertising effects desired by an advertiser can be obtained in such a manner that a search listing as search results is displayed at a display location desired by the advertiser through input of a bid price and a predetermined bid process.

A further object of the present invention is to provide a method for controlling a keyword advertisement and a system thereof, wherein display of a search listing at a specific display location is selected through a bid, and a search listing can be displayed in real time without a bid waiting period through input of proper bid data.

A still further object of the present invention is to provide a method for controlling a keyword advertisement and a system thereof, wherein a rational bid process is performed in such a manner that the highest fee per single click, which is payable by each advertiser, is included in bid data submitted by the advertiser and successful bid data are selected through comparison of the fees for a single click.

### Technical Solution

According to an aspect of the present invention for achieving the objects, there is provided a method for controlling display of a keyword advertisement comprises the steps of defining, in response to input of a keyword by a searcher, a plurality of locations where search listings are displayed on a web page, as unit display zones in association with the keyword; receiving bid data corresponding to a first unit display zone, which is one of the plurality of unit display zones associated with the predetermined keyword, from an advertiser; associating the advertiser with a predetermined search listing; receiving automatic bid data corresponding to at least one unit display zone except the first unit display zone, among the plurality of unit display zones associated with the keyword, from the advertiser; if the bid data of the advertiser are successfully bidden through a predetermined bid process for the first unit display zone, assigning a display right in the first display zone to the search listing associated with the advertiser; if a predetermined transfer condition for the assigned display right is satisfied, depriving the search listing associated with the advertiser in the first unit display zone of the display right; and if the search listing in the first unit display zone is deprived of the display right, performing a re-bid process for the input automatic bid data.

Furthermore, according to another aspect of the present invention for achieving the objects, there is provided a keyword advertisement display control system comprising a location defining means that, in response to input of a keyword by a searcher, defines a plurality of locations where search listings are displayed on a web page, as unit display zones in association with the keyword; an interface means that receives bid data corresponding to a first unit display zone of the plurality of unit display zones associated with the keyword, and automatic bid data corresponding to at least one unit display zone except the first unit display zone among the plurality of unit display zones associated with the keyword, from the advertiser; a bid processing means that, if the bid data of the advertiser are successfully bidden through a predetermined bid process in the first unit display zone, assigns a display right in the first display zone to the search listing associated with the advertiser; and a display right transfer means that, if a predetermined transfer condition for the assigned display right is satisfied, deprives the search listing associated with the advertiser in the first unit display zone of the display right. Here, the bid processing means performs a re-bid process for the input automatic bid data if the search listing in the first unit display zone is deprived of the display right.

### BRIEF DESCRIPTION OF DRAWINGS

FIG. 1 is a schematic view illustrating the configuration of a keyword advertisement display control system according to the present invention.

FIG. 2 is a block diagram showing the configuration of a keyword advertisement display control system according to a preferred embodiment of the present invention.

FIG. 3 shows an example of unit display zones constituting identification locations and search listings displayed in the unit display zones according to the present invention.

FIGS. 4 and 5 are views showing examples of the configuration of a bid field.

FIG. 6 is a view showing an example of a first search listing displayed according to a bid process for a first unit display zone and a bid selection of a first advertiser.

FIG. 7 is a flowchart specifically illustrating a method for controlling display of a keyword advertisement according to a preferred embodiment of the present invention.

FIG. 8 is a flowchart illustrating an example of a method for independently recording bid data or betting bid data by associating unit display zones with record areas of a bid field according to the present invention.

FIG. 9 is a flowchart illustrating an example of a method for performing a bid process for a unit display zone according to the present invention.

FIG. 10 is a flowchart illustrating an example of a method for transferring a display right when new bid data are received as a transfer condition according to the present invention.

FIG. 11 is a flowchart illustrating an example of a method for transferring a display right when a contract for display of a first search listing is expired as a transfer condition.

FIG. 12 is a flowchart illustrating an example of a method for performing an automatic re-bid process in association with display of a first search listing according to the present invention.

FIG. 13 is a block diagram showing the inner configuration of a general-purpose computer system that can be employed in performing the method for controlling a keyword advertisement according to the present invention.

### BEST MODE FOR CARRYING OUT THE INVENTION

Hereinafter, a method for controlling a keyword advertisement and a system thereof according to the present invention will be described in detail with reference to the accompanying drawings.

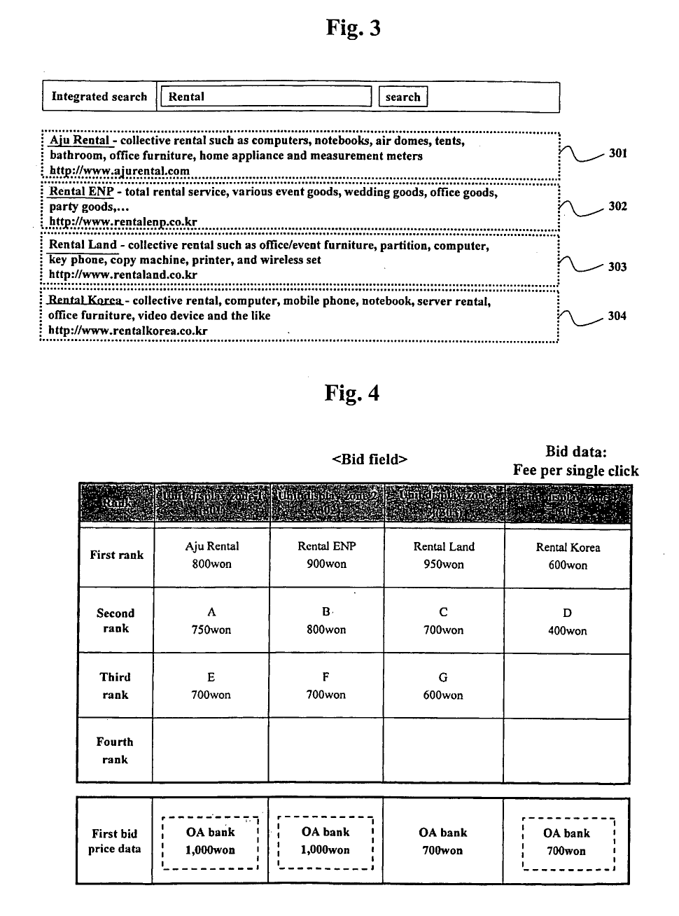

The term “search listing” used herein can mean one item of search results that are extracted in response to a search request produced by means of input of a keyword into a search engine by a searcher. One search listing may include summary information on an information website that is operated by an advertiser, i.e., a content title, a content summary, a network address and the like. For example, one of search listings, which are extracted/displayed according to a keyword “rental” in FIG. 3, includes a content title “Aju Rental”, a network address “http://www.ajurentel.com”, a content summary, and the like. Furthermore, a unit display zone is an independent display location of each of search listings, which are extracted as search results. More particularly, a unit display zone in the present invention becomes the subject of a bid. The keyword advertisement display control system according to the present invention can receive bid data required for displaying search listings in predetermined unit display zones from one or more advertisers. For example, unit display zones can be associated with locations of search listings output when a keyword is input into a search engine. That is, when a keyword is input, the location of a first search listing that will be output or the location of an N-th search listing that will be output can be a unit display zone. Accordingly, search listings that are extracted through a keyword search are displayed in predetermined unit display zones through a predetermined bid process and then provided to a searcher.

FIG. 1 is a schematic view illustrating the configuration of a keyword advertisement display control system according to the present invention.

The keyword advertisement display control system 100 is an apparatus in which bid data required for displaying a search listing in a specific unit display zone are received from each advertiser 130, and one search listing that will be displayed in the corresponding unit display zone is determined through a predetermined bid process for the bid data.

A search engine 110 may refer to a search program or a search web server that supports a search to facilitate access to a website that maintains content data for which a searcher 120 wants to seek. That is, the search engine 110 provides brief information (preferably, a search listing of the present invention) on an advertiser 130 who can provide information requested by the searcher 120 in response to a search request from the searcher 120. Thus, time required for searching content data can be saved and the accuracy of searched data can be improved. More particularly, extracted brief information (search listing) includes predetermined link information. When the searcher 120 makes selection through click on a command input tool (e.g., click on a mouse) for brief information (search listing) displayed on a terminal means 125, the search engine 110 provides connection between the corresponding advertiser 130 and the searcher 120 that has generated the click selection. The search engine 110 can provide word-oriented searching, subject-oriented searching, or the like according to the access mode of a search. A description is made herein on the assumption that the search mode of the search engine 110 is word-oriented searching in order to accomplish the object of the present invention, wherein search listings extracted according to an input keyword are controlled to be displayed only in predetermined unit display zones under a predetermined condition. However, the limitation of the search of the search engine 110 to the word-oriented searching mode is only illustrative for the sake of convenience of description. Those skilled in the art will appreciate that the present invention is not limited thereto.

The searcher 120 may refer to an Internet user who has the terminal means 125 for access to the keyword advertisement display control system 100 according to the present invention and generates a search request for a website of the advertiser 130, which maintains content data to be searched, by inputting a predetermined keyword into the search engine 110.

The advertiser 130 may refer to a content provider (CP) that operates a website of which location on a network is designated based on a network address (e.g., IP address, URL, domain, etc.). The advertiser 130 pays a predetermined advertising fee to a system operator according to the present invention when the searcher 120 clicks on a search listing of a corresponding information website.

The terminal means 125 maintains an access state with the keyword advertisement display control system 100 through a communication network 140 such as the Internet, and displays one or more search listings, which are extracted through the search of the search engine 110, on a predetermined screen. The terminal means 125 may refer to a terminal, such as a personal computer, a handheld computer, PDA (Personal Digital Assistant), a MP3 player, an electronic dictionary, a mobile phone and a smart phone, which has a predetermined memory means and predetermined microprocessors capable of performing predetermined operation ability.

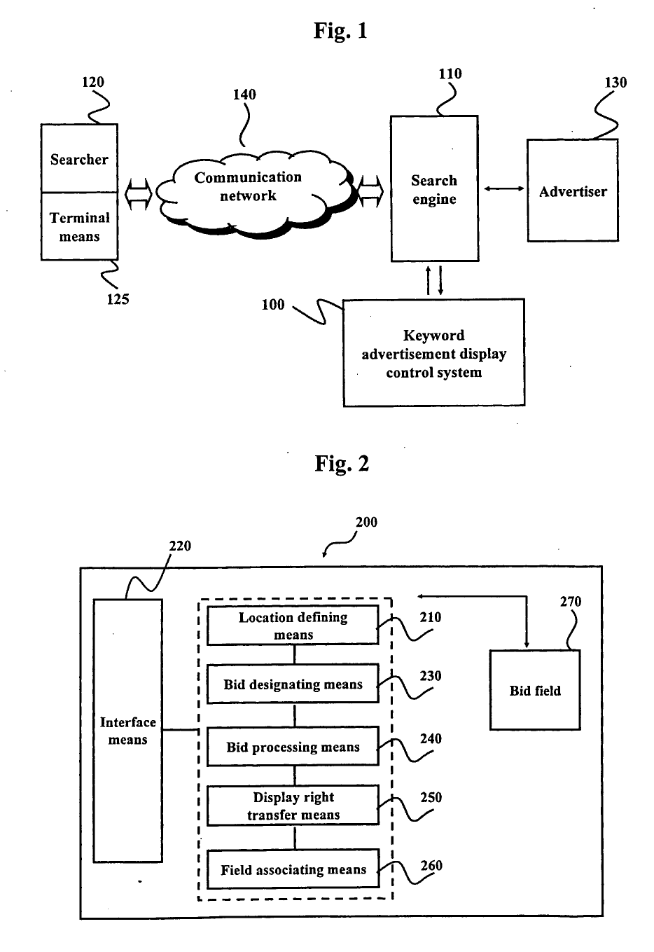

The keyword advertisement display control system 100 serves to receive bid data for one or more unit display zones in relation to the display of search listings, and to control a bid process to be performed only in one unit display zone that is designated by the advertiser 130. More particularly, the keyword advertisement display control system 100 maximally guarantees successive display of a search listing in such a manner that a right to display a search listing in a specific unit display zone is deprived under a predetermined transfer condition, and an automatic re-bid associated with the corresponding search listing is then performed for a different unit display zone. The detailed configuration of a keyword advertisement display control system 200 according to the present invention will be described with reference to FIG. 2.

FIG. 2 is a block diagram showing the configuration of a keyword advertisement display control system according to a preferred embodiment of the present invention.

The keyword advertisement display control system 200 comprises a location defining means 210, an interface means 220, a bid designating means 230, a bid processing means 240, and a display right transfer means 250. The keyword advertisement display control system 200 further comprises a field associating means 260 and a bid field 270, and controls recordation of one or more pieces of bid data that are input from the advertiser 130.

The location defining means 210 is a device for dividing display locations where search listings extracted according to a keyword search are displayed into one or more unit display zones. The location defining means 210 defines the unit display zones in consideration of arrangement of search listings to be provided to the searcher 120 on a screen, actual click connection rates depending upon display locations (unit display zones in the present invention) of search listings, and so on. Such division of the display locations into the unit display zones is necessary due to a difference in the recognition degree of the searcher 120 for search listings according to display locations on the screen, and a difference in the frequency of access connections between the searcher 120 and the advertiser 130, which are made according to actual click selection by the searcher 120. Generally, a search listing that is first displayed among a number of extracted search listings has a high CTR, i.e., the high number of clicks versus display. The location defining means 210 can divide a predetermined number of unit display zones in consideration of CTRs, for example, at an upper portion on a search screen having higher CTRs. The unit display zones divided by the location defining means 210 may refer to display locations on a search screen on which at least some of search listings extracted according to a keyword search are independently displayed. That is, the unit display zone may refer to a region which is divided to be occupied at a display location under a predetermined condition and has been successfully bidden through a predetermined bid process, and where preferably one search listing is displayed.

The interface means 220 is a device that receives one or more pieces of betting bid data associated with display of a first search listing in each of unit display zones from a first advertiser. In this case, the first search listing refers to a search listing, which is associated with the first advertiser (a specific one of a plurality of advertisers). The betting bid data refer to bid information which is selectively input by the first advertiser into a unit display zone in which the first search listing will be displayed. For example, in FIG. 4, a first advertiser “OA Bank” inputs betting bid data into four unit display zones. Accordingly, the first search listing associated with the first advertiser “OA Bank” can be displayed in a predetermined one of the four unit display zones based on a bid process for the input betting bid data and on a bid selection by the first advertiser among betting bid data (valid bid data) which are successfully bidden through the bid process (see FIG. 6). More particularly, betting bid data include the highest fee per single click that is payable by the advertiser 130 in displaying one search listing in a unit display zone. That is, the interface means 220 serves to receive the intention of the advertiser 130 to participate in a bid in order to display a search listing at a display location, wherein information on a fee per click of the searcher 120 on a corresponding search listing is received as betting bid data for bid participation.

Furthermore, the interface means 220 serves to receive betting bid data including certain fees for a single click for at least some of unit display zones constituting display locations, and to receive from the advertiser 130 information on a bid selection for designating only one piece of data among one or more pieces of valid bid data (successful bidden betting bid data) which are determined through a bid process for input betting bid data. In this case, the betting bid data can be betting information in each of unit display zones for displaying a first search listing, and the fees for a single click included in the betting bid data may be identical to or different from one another in the respective unit display zones. That is, if advertisers input betting bid data for a plurality of unit display zones, successfully bidden betting bid data for each of the unit display zones are determined based on the input betting bid data. The successfully bidden betting bid data become valid bid data. If one advertiser inputs betting bid data for a plurality of unit display zones, no valid bid data may exist (nothing is successfully bidden), only one piece of valid bid data may exist (only one piece of data is successfully bidden) or two or more pieces of valid bid data may exist (two or more pieces of data are successfully bidden). In a case where there are two or more pieces of valid bid data, an advertiser who wants to put an advertisement only in one unit display zone rather than a plurality of unit display zones for one keyword can select one of the plural pieces of valid bid data. A search list of the advertiser is displayed in a unit display zone associated with the selected valid bid data.

The bid designating means 230 is a device that determines one piece of valid bid data, which are associated with bid participation in a predetermined first unit display zone, among successfully bidden betting bid data, by means of a bid selection by a first advertiser. That is, the bid designating means 230 serves to designate one unit display zone for which a first advertiser actually wants to make a bid, among one or more unit display zones associated with successfully bidden betting bid data, as a first unit display zone. In this case, valid bid data can refer to betting bid data, which are successfully bidden through a bid process for each of unit display zones after betting bid data are input. That is, the bid designating means 230 determines one valid bid data according to a bid selection among successfully bidden betting bid data by a first advertiser, and determines a unit display zone associated with the determined valid bid data as a first unit display zone for which the first advertiser preferentially wants to make a bid. For example, FIG. 4 illustrates that valid bid data corresponding to unit display zone 1 is determined by means of a bid selection by the first advertiser “OA Bank” among three valid bid data that have been successfully bidden. Accordingly, the fact that the first advertiser “OA Bank” preferentially wants his/her first search listing to be displayed in unit display zone 1 can be recognized by the keyword advertisement display control system 200 according to the present invention. Furthermore, the first unit display zone refers to a specific unit display zone associated with valid bid data determined by means of a bid selection. In FIG. 4, unit display zone 1 is set to a first unit display zone. That is, the bid designating means 230 serves to recognize a unit display zone for which a first advertiser actually wants to make a bid, by determining only one of one or more pieces of valid bid data according to a bid selection of the first advertiser. At this time, the remaining valid bid data for which a bid selection is not made by the first advertiser or betting bid data that have not been successfully bidden through a bid process are automatically determined as automatic bid data and can be utilized in an automatic re-bid that will be described later.

The bid processing means 240 is a device that performs a bid process for display zones to which betting bid data are applied and selects (makes a successful bid) bid data with the highest fee per unit click which is included in the bid data (including betting bid data). That is, the bid processing means 240 performs a bid process for bid data that include betting bid data recorded in a predetermined bid field 270, and determines bid data with the highest fee per single click as successful bid data. More particularly, if betting bid data, which are input by a first advertiser, in a corresponding unit display zone are successfully bidden, the bid processing means 240 also determines them as valid bid data. Furthermore, the bid processing means 240 determines a corresponding unit display zone as a first unit display zone if one valid bid data are determined according to a bid selection of a first advertiser, and assigns a display right in the first unit display zone to a first search listing. The display right can refer to a right to display a predetermined search listing in a unit display zone. The display right assigned to the search listing can be successively maintained during a predetermined contract period or when there is a predetermined amount of deposit that can be used as payment for advertising costs.

In order to record these bid data and compare the fees for a single click with one another, the keyword advertisement display control system 200 according to the present invention includes the field associating means 260 and the bid field 270.

The field associating means 260 is a device that associates a unit display zone with a predetermined bid field 270 in response to input of bid data by an advertiser 130 and records the input bid data in the bid field 270. In this case, the bid field 270 serves to align and record the input bid data on the basis of the amount of fee per single click. More particularly, the bid field 270 records the bid data in a predetermined record area corresponding to a unit display zone for which the advertiser 130 wants to make a bid. That is, the field associating means 260 associates a display location with the bid field 270, more specifically, each unit display zone with a record area, and records bid data in a corresponding record area of a unit display zone for which the advertiser 130 wants to make a bid.

Accordingly, the bid processing means 240 performs a bid process for one or more bid data that are recorded in the bid field 270 if a predetermined bid condition is fulfilled, and assigns a rank to each of bid data according to the amount of fee per single click. In this case, as for assignment of a rank, a higher grade is assigned to bid data with a higher fee per single click. Accordingly, the bid processing means 240 determines bid data with the highest fee per single click (first grade) among bid data within the bid field 270, as successful bid data. In this case, the bid condition can be bid data newly input by the advertiser 130 for a predetermined unit display zone. The bid processing means 240 compares the newly input bid data with bid data (or bid data recorded in the bid field 270) of a search listing that is displayed in a current corresponding unit display zone, and determines bid data with a higher fee per single click as the subject of a successful bid. Therefore, there is an advantage in that the objects of the present invention for rapidly determining successful bid data through a real-time bid process according to input of new bid data and for displaying a corresponding search listing in real time can be faithfully accomplished. In the present invention, the bid condition has been described by way of example as being the input of new bid data. However, this is merely a preferred embodiment of the present invention. For example, if a condition under which a display right of a search listing that is being displayed is lost is satisfied, a variety of bid conditions, such as a condition under which a bid process is performed only for bid data that wait for an opportunity to be displayed while having been recorded in a corresponding record area of the bid field 270, can be defined. This bid condition can be flexibly set by an operator of the present system in consideration of a system environment.

Furthermore, in a case where betting bid data input by a first advertiser are determined as successful bid data, which have the highest fee per single click in a predetermined record area, and are selected by the first advertiser, the bid processing means 240 displays a first search listing in a first unit display zone in response to a keyword search of the searcher 120. Accordingly, the first search listing of the advertiser 130, i.e., the first advertiser, is displayed as search results according to the keyword search of the searcher 120, and is then provided to the searcher 120.

The display right transfer means 250 is a device that controls transfer of a right to display a first search listing in a first unit display zone to a predetermined second search listing that has participated in a bid for the first unit display zone, if a predetermined transfer condition is satisfied. In this case, the transfer condition is a condition under which a search listing having a display right in a predetermined unit display zone is deprived of the display right. This means that the first search listing is no longer displayed in the first unit display zone. Furthermore, the second search listing corresponds to bid data from a second advertiser (a specific one of a plurality of advertisers except the first advertiser). For example, the second search listing can be a search listing corresponding to bid data that hold the second highest fee per single click waiting for an opportunity to be displayed, or new bid data that have a fee higher than a fee per single click in valid bid data currently having a display right in the first unit display zone. In other words, the display right transfer means 250 serves to deprive (redeem) valid bid data of a display right if a transfer condition under which the display of the first search listing in the first unit display zone is not further allowed is met. The deprival of the display right by the display right transfer means 250 induces an automatic re-bid by the bid processing means 240. As the display right is transferred, the bid processing means 240 performs a bid process again in association with display of the first search listing in second unit display zones (remaining unit display zones except the first unit display zone). Accordingly, there is an advantage in that the object of the present invention for maximally guaranteeing the display of a first search listing is faithfully accomplished.

Hereinafter, a bid process for bid data and the display of a first search listing performed by the keyword advertisement display control system 200 will be described with reference to FIGS. 3 to 6.

FIG. 3 shows an example of unit display zones constituting identification locations and search listings displayed in the unit display zones according to the present invention.

FIG. 3 illustrates search listings in respective unit display zones 301 to 304, which are extracted/displayed when the searcher 120 inputs a keyword “rental” into the search engine 110. The location defining means 210 first defines regions of a search screen with search listings, i.e., search results, displayed thereon as identification locations, and defines the unit display zones 301 to 304 each of which displays only a predetermined one of a plurality of extracted search listings. In the present embodiment, search listings, which are extracted according to the keyword “rental”, are displayed in the four unit display zones 301 to 304, respectively. Accordingly, the four search listings are displayed to the searcher 120 as the search results for the keyword “rental”. If the searcher 120 generates a selection signal by clicking on one of the displayed search listings, the search engine 110 connects the searcher 120 to an information website of a corresponding advertiser 130.

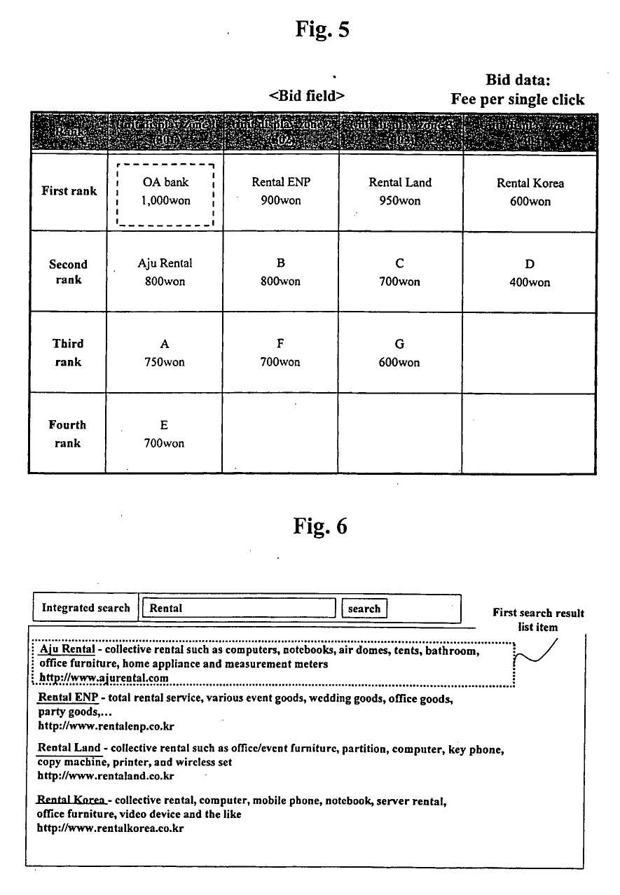

FIGS. 4 and 5 are views showing examples of the configuration of a bid field. FIG. 4 shows an example of betting bid data that are input by a first advertiser, and FIG. 5 is a view illustrating an example of a bid process for one piece of valid bid data for which a bid selection is made among valid bid data.

As shown in FIG. 4, in the bid field 270, input bid data are separately recorded in areas of unit display zones 301 to 304. The bid data within the areas of unit display zones 301 to 304 are arranged according to the amount of fee per single click included in the bid data. That is, the keyword advertisement display control system 200 recognizes a predetermined unit display zone in which the advertiser 130 wants to display information, and controls bid data to be arranged and recorded in a record area corresponding to a corresponding unit display zone. For example, the interface means 220 can receive a predetermined bid participation signal, which designates unit display zone 1 301, from the advertiser 130 who wants to display a search listing related to unit display zone 1 301. The field associating means 260 in the present invention stores bid data, which are input by three advertisers 130 who have generated a bid participation signal for unit display zone 1 301, i.e., “Aju Rental”, “A” and “E”, in a record area of the bid field 270 corresponding to unit display zone 1 301. Further, the bid processing means 240 compares fees for single click in bid data with one another, which are input by the advertisers “Aju Rental”, “A” and “E”, and arranges the bid data of the advertiser “Aju Rental”, which have the highest fee per single click, at the top position. In other words, as shown in FIG. 4, the bid data of the advertiser “Aju Rental” can be assigned the first rank. Therefore, the keyword advertisement display control system 200 according to the present invention controls a search listing of the advertiser “Aju Rental” to be displayed in unit display zone 1 301 on a search screen provided to the searcher 120 if there is a search request for a keyword “rental”. Search listings to be displayed in unit display zone 2 302 to unit display zone 4 304 are determined through the same process. The bid processing means 240 performs control such that search listings associated with advertisers “Rental ENP”, “Rental Land” and “Rental Korea” each of which has the highest rank in each of the record areas can be displayed (see FIG. 3).

If betting bid data shown in FIG. 4 are input by a first advertiser in a state where bid data have been recorded in the bid field 270, the keyword advertisement display control system 200 performs a bid process for each of unit display zone 1 301 to the unit display zone 4 304 on the basis of fees for unit click, and makes successful bids for betting bid data that participate in bids for unit display zone 1 301, unit display zone 2 302 and unit display zone 4 304, respectively. In other words, the keyword advertisement display control system 200 determines three pieces of betting bid data among four pieces of betting bid data, which have been input by the first advertiser “OA Bank”, as valid bid data. The keyword advertisement display control system 200 then waits for a bid selection among the three valid bid data by the first advertiser “OA Bank”. The bid selection is to determine a specific one of unit display zones, which are successfully bidden, according to the intention of the first advertiser who wants to preferentially display information in the specific unit display zone. Valid bid data for which a bid selection is made are assigned a display right in the corresponding unit display zone.

For example, if a first advertiser makes a bid selection in connection with unit display zone 1 301 as shown in FIG. 4, the bid designating means 230 designates corresponding unit display zone 1 301 as a first unit display zone, and performs control such that a first search listing is displayed in the designated first unit display zone. That is, in a case where unit display zone 1 301 is designated by a first advertiser “OA Bank” as a first unit display zone in which a relevant search listings will be preferentially displayed, the bid designating means 230 controls bid data, which have been stored in connection with unit display zone 1 301, to be arranged with valid bid data set to the highest rank.

FIG. 5 shows a case where betting bid data of a first advertiser, which are input corresponding to unit display zone 1 301, are determined as valid bid data for which a bid selection is made. As described above, the bid control means 240 performs a bid process for input betting bid data, and bid data already recorded in association with unit display zone 1 301, in response to the input of betting bid data. That is, the bid control means 240 aligns bid data associated with unit display zone 1 301, and determines betting bid data of the first advertiser “OA Bank”, which have the highest fee per single click, as valid bid data (successful bid data), as shown in FIG. 5. The advertiser “OA Bank” then makes a bid selection for valid bid data related to unit display zone 1 301. Accordingly, the display right for unit display zone 1 301 is transferred from the advertiser “Aju Rental” to the first advertiser “OA Bank”, so that a corresponding search listing of the first advertiser “OA Bank” is displayed in unit display zone 1 301. In this case, bid data of the advertiser “Aju Rental” drops to the second highest rank and then waits for display. As shown in FIG. 5, in the present embodiment, it has been illustrated that a fee per single click in bid data which have the first rank in unit display zone 3 303 having a relatively low CTR, is higher than that of bid data which have the first rank in unit display zone 2 302 having a relatively high CTR. This can guarantee an independent bid process and billing cost determination for each of unit display zones 301 to 304 regardless of CTRs.

FIG. 6 is a view showing an example of a first search listing displayed according to a bid process for a first unit display zone and a bid selection of a first advertiser.

The bid processing means 240 controls a display right in unit display zone 1 301 to be transferred from the advertiser “Aju Rental” to the first advertiser “OA Bank” according to the aforementioned bid process, and controls the first search listing related to the first advertiser “OA Bank” to be displayed in unit display zone 1 301, as shown in FIG. 6. Therefore, the first advertiser “OA Bank” can display the first search listing associated therewith (or his/her company) at a desired display location in a proper manner.

Furthermore, if unit display zone 1 301 as the first unit display zone is deprived (redeemed) of the right to display the first search listing therein, the keyword advertisement display control system 200 performs an automatic re-bid for a first search listing in a second unit display zone, i.e., unit display zone 2 302 to unit display zone 4 304. To this end, the bid designating means 230 can determine betting bid data, which are not determined as valid bid data, and valid bid data for which a bid selection is not made, as automatic bid data, and controls a bid process for the automatic bid data to be performed in the second unit display zone, thereby ensuring that the first search listing can be maximally displayed.

The automatic re-bid for the first search listing will be described with reference to FIGS. 4 and 5.

It is first assumed that the right to display the first search listing in unit display zone 1 301 is deprived due to generation of a predetermined transfer condition. In this case, the display right transfer means 250 can transfer the deprived display right in unit display zone 1 301 to the second highest bid data (Aju Rental), which waits for display, or to new bid data having a fee per single click higher than that of valid bid data. Further, the bid processing means 240 performs a bid process in the second unit display zone for automatic bid data of the first advertiser. At this time, if the number of pieces of automatic bid data, which are successfully bidden according to an automatic re-bid, is two or more, the bid processing means 240 determines one unit display zone in which the first search listing is displayed on the basis of a predetermined display priority condition. In this case, the display priority condition becomes a basis on which one optimal second unit display zone is determined when the number of second unit display zones, which are successfully bidden through the automatic re-bid, is two or more. In the present embodiment, the display priority condition can include an arrangement order of second unit display zones associated with automatic bid data that are successfully bidden, a fee per single click in automatic bid data that are successfully bidden, selection of automatic bid data that are successfully bidden by an advertiser, and the like. Referring to FIGS. 4 and 5, unit display zones in which automatic bid data in the second unit display zone for the first advertiser “OA Bank” are successfully bidden are unit display zone 2 302 and unit display zone 4 304 on the basis of the amount of fee per single click. That is, betting bid data having the first rank in a corresponding record area through the automatic re-bid, among betting bid data that have been previously input by the first advertiser, become betting bid data, which are input corresponding to unit display zone 2 302 and unit display zone 4 304 according to the amount of fee per single click, preferably valid bid data for which a bid selection is not made.

First of all, if “the arrangement order of second unit display zones” is applied as the display priority condition, the keyword advertisement display control system 200 controls a first search listing corresponding to the first advertiser “OA Bank” to be displayed only in unit display zone 2 302 but not to be displayed in unit display zone 4 304. That is, the display priority condition “the arrangement order of unit display zones” is to control a search listing to be displayed in a unit display zone having a higher CTR (clicks versus display). This allows the advertiser 130 to have better advertising effects.

Further, if “the amount of fee per single click” is applied as the display priority condition, the keyword advertisement display control system 200 controls a first search listing corresponding to the advertiser “OA Bank” to be displayed, for example, in unit display zone 4 304 with a fee per single click of “700 Korean won” rather than unit display zone 2 302 with a fee per single click of “1,000 Korean won”. That is, the display priority condition “the amount of fee per single click” is to compare fees for single click in automatic bid data that are successfully bidden, and to induce a search listing to be displayed in a unit display zone into which a lower fee per single click has been input. This allows a search listing to be billed at lower advertising costs. Thus, there is an advantage in that advertising costs billed to the advertiser 130 can be saved. In an embodiment of this display priority condition, it has been described that a unit display zone into which automatic bid data having a lower fee per single click are input is designates as a display location in which a first search listing will be displayed. However, this is merely illustrative for convenience of description. It will be apparent that there may be a variety of methods, such as a method in which a unit display zone into which automatic bid data having a higher fee per single click are input is designated as a display location in which a first search listing is displayed. It will be apparent to those skilled in the art that the method for designating a unit display zone in which a first search listing will be displayed can be flexibly selected by an operator of the present system in consideration of a system environment.

Further, if “selection of an advertiser” is applied as the display priority condition, the keyword advertisement display control system 200 notifies the first advertiser “OA Bank” of information on a successful bid of automatic bid data, and determines a unit display zone in which a first search listing will be displayed in response to a selection signal of the first advertiser “OA Bank”. That is, the display priority condition “selection of an advertiser” is to guarantee an active selection of a first advertiser. In this condition, a unit display zone in which a search listing will be displayed can be determined as unit display zone 2 302 or unit display zone 4 304 according to an arbitrary selection of the first advertiser “OA Bank”.

Accordingly, even though a first search listing is deprived of a right to be displayed in a first unit display zone, the first search listing can be successively displayed on a different unit display zone through an automatic re-bid. Therefore, the present invention has an advantage in that an advertiser can have successive advertising effects. Further, a search listing to be displayed is determined according to a bid process based on input of a fee per single click. Accordingly, the present invention has an advantage in that real-time display can be obtained without waiting time for a bid.

In the present embodiment, it has been described that betting bid data, which are successfully bidden through a bid process for one or more pieces of input betting bid data, are selected as valid bid data, and remaining valid bid data except one piece of valid bid data for which a bid selection is made among the selected valid bid data, or betting bid data that are not successfully bidden are determined as automatic bid data. However, it will be apparent to those skilled in the art that this is merely an embodiment of the present invention.

In other words, in another embodiment of the present invention, input timing of automatic bid data may not be specially limited. For example, in a state where a display right in a first unit display zone is assigned to a first search listing, automatic bid data on some of remaining unit display zones can be received from a first advertiser. An automatic re-bid process for these automatic bid data can be performed as described above when the transfer condition in the first unit display zone (the condition under which a first search listing is deprived of a display right in the first unit display zone) is satisfied.

Accordingly, according to the present embodiment, there is an advantage in that it is possible to guarantee expanded development of a variety of service models that can be induced from the present invention since input timing of automatic bid data can be flexibly controlled.

As another embodiment of the present invention, it is possible to determine advertising costs for a search listing displayed in a unit display zone.

To this end, the keyword advertisement display control system 200 according to the present invention can further include billing control means (not shown). The billing control means is a device that determines advertising costs that are added when a searcher 120 clicks on a displayed search listing once. More particularly, the keyword advertisement display control system 200 determines advertising costs by referring to the second highest fee per single click in bid data that are arranged in the bid field 270. At this time, the advertising costs are advertising costs for a search listing which is displayed in one of unit display zones 301 to 304, and mean costs generated when the searcher 120 clicks. As for actual billing settlement of advertising costs, determined advertising costs can be subtracted from deposits of a corresponding advertiser 130 in response to a click by the searcher 120. In addition, there may be a variety of methods for determining advertising costs, such as a method in which a fee per single click included in successful bid data as advertising costs of a search listing is determined directly as advertising costs.

For example, it is assumed in FIG. 4 that the billing control means recognizes a fee per single click in bid data which are arranged to have the second highest rank in the bid field 270, i.e., a second rank, and a predetermined additional charge “+10 Korean won” is applied to each fee per single click. Accordingly, the billing control means determines “750+10 Korean won” for unit display zone 1 301, “800+10 Korean won” for unit display zone 2 302, “700+10 Korean won” for unit display zone 3 303, and “400+10 won” for unit display zone 4 304, as advertising costs associated with the display of a search listing in each of unit display zones 301 to 304. That is, in a case where search listings, which are extracted and displayed when the searcher 120 inputs a keyword “rental”, are “Aju Rental”, “Rental ENP”, “Rental Land” and “Rental Korea”, as shown in FIG. 3, if the searcher 120 clicks on a corresponding search listing in order to make connection to “Aju Rental”, the billing control means levies advertising costs of “850 Korean won” on the advertiser 130 of “Aju Rental”.

Thus, according to the present invention, there are advantages in that rational billing settlement is enabled and the advertiser 130 can obtain more economic and efficient advertising effects since advertising costs are levied when the searcher 120 clicks on a displayed search listing.

In the present embodiment, it has been described that advertising costs are levied according to the number of clicks by the searcher 120. However, this is only an embodiment of the present invention. It will be apparent that there may be a variety of methods for levying advertising costs, for example, based on the number of times of display of a search listing, the number of effective clicks on a search listing (the number of hits) and the number of times of purchase associated after connection to the advertiser 130. Further, a method may be based on an amount of money that is payable by an advertiser while being levied in association with the above factors. Moreover, it is possible to adopt a method in which the above factors are considered in combination. The adoption of a method for levying advertising costs can be flexibly changed and set by an operator of the present system in consideration of a system environment.

The sequential operation of the keyword advertisement display control system 200 constructed as above according to the present invention will be described in detail.

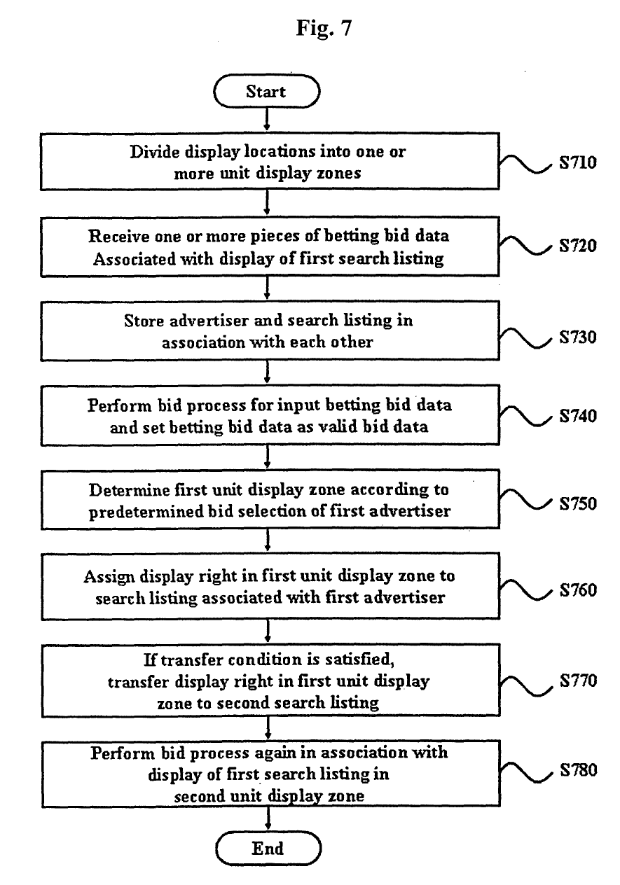

FIG. 7 is a flowchart specifically illustrating a method for controlling display of a keyword advertisement according to a preferred embodiment of the present invention.

The method for controlling display of a keyword advertisement according to the present embodiment is performed by the aforementioned keyword advertisement display control system 200.

First, the keyword advertisement display control system 200 divides display locations where search listings extracted through a predetermined keyword search are displayed into one or more unit display zones 301 to 304 (S710). Step S710 is a process of determining locations where extracted search listings will be placed on a screen as the searcher 120 inputs a keyword. For example, in this process, the location defining means 210 can define the top of a search screen as a display location in consideration of a CTR. Further, in step S710, the keyword advertisement display control system 200 guarantees independent display of extracted search listings by dividing display locations into one or more unit display zones 301 to 304. Such division into the unit display zones 301 to 304 is to perform a bid for each of the unit display zones 301 to 304, and to display a specific search listing only at a display location desired by the advertiser 130. This can faithfully accomplish the object of the present invention for positively reflect the intention of the advertiser 130.

Furthermore, the keyword advertisement display control system 200 receives one or more pieces of betting bid data, which are associated with display of a first search listing in each of the unit display zones 301 to 304, from a first advertiser (S720). Step S720 is a process in which betting bid data, which are related to participation in a bit for each of the unit display zones 301 to 304, are received from a first advertiser who wants to display his/her (company's) search listing at a specific display location in response to a search request of the searcher 120. In this process, each piece of the betting bid data includes the highest fee per single click that is payable by the advertiser 130 if a first search listing is extracted/displayed through a search. This fee per single click becomes a kind of betting price for participation in a bid. In the present embodiment, the keyword advertisement display control system 200 receives betting bid data that include a predetermined fee per single click for each of unit display zones constituting display locations.

Moreover, the keyword advertisement display control system 200 associates the advertiser 130 with a predetermined search listing (S730). Step S730 is a process in which a search listing associated with the advertiser 130 is received and stored in a search information database (not shown) so that it can be associated with the corresponding advertiser 130. Accordingly, the advertiser 130 can store a search listing that will be advertised in association with him/her (or his/her company).

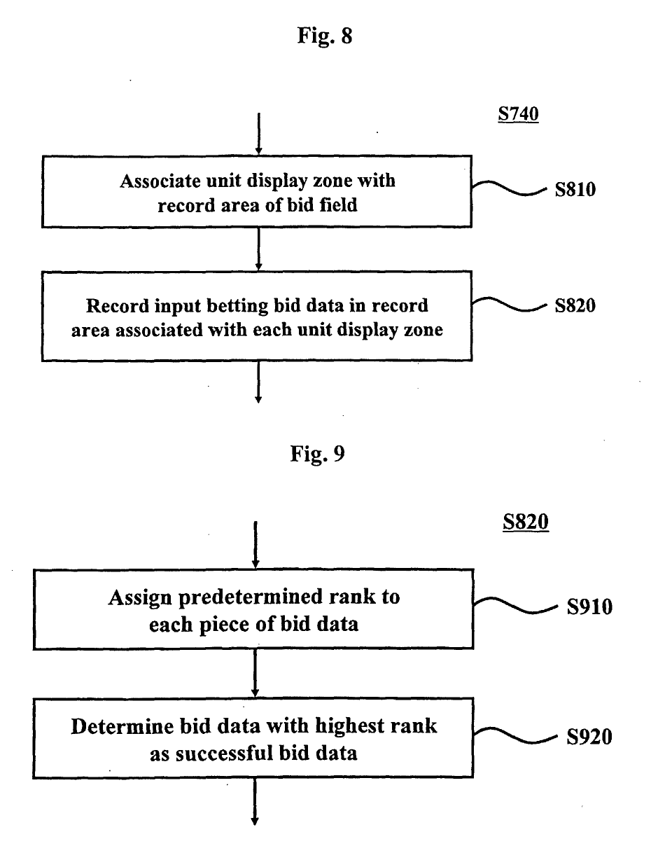

Subsequently, the keyword advertisement display control system 200 carries out a predetermined bid process for input betting bid data, and sets at least one or more pieces of betting bid data, which are successfully bidden, as valid bid data (S740). Step S740 is a process in which a first unit display zone which a first advertiser actually wants to participate in among one or more unit display zones 301 to 304 is recognized by the keyword advertisement display control system 200 according to a bid selection. For example, a bid selection for a first unit display zone can be made through current status information on the bid field 270, which is provided to a predetermined terminal means (not shown) of a first advertiser, current status information on betting bid data that are successfully bidden according to a bid process, and input of a selection of current status information by the first advertiser. That is, the keyword advertisement display control system 200 receives betting bid data, which include a fee per unit click for each of the unit display zones 301 to 304, from a first advertiser who is provided with the current status information as shown in FIG. 4, and determines betting bid data, which are successfully bidden in predetermined unit display zones 301, 302 and 304 through a bid process for the received betting bid data, as valid bid data. In association with a click on a specific unit display zone, for example, using a computer mouse, as a bid selection of a first advertiser, the keyword advertisement display control system 200 then determines a corresponding unit display zone as the first unit display zone 301. More particularly, step S740 can include a process in which the keyword advertisement display control system 200 associates each of predetermined record areas of the bid field 270 in which betting bid data are recorded with each of the unit display zones into which the display locations are divided. This process will be described in greater detail with reference to FIG. 8.

FIG. 8 is a flowchart illustrating an example of a method for independently recording bid data or betting bid data of an advertiser by associating unit display zones with record areas of a bid field according to the present invention.

Here, a bid field can be divided into one or more record areas on the basis of the unit display zones 301 to 304. The keyword advertisement display control system 200 associates the unit display zones 301 to 304 with a predetermined bid field 270 in response to input of betting bid data (S810). Step S810 is a process in which the bid field 270 where bid data received from an advertiser 130 or betting bid data input by a first advertiser will be recorded is associated with specific display locations at which search listings will be displayed. More particularly, in step S810, the keyword advertisement display control system 200 associates each of predetermined record areas of the bid field 270 with each of the unit display zones 301 to 304 into which the display locations are divided.

The keyword advertisement display control system 200 then records received betting bid data in the predetermined record areas associated with the respective unit display zones (S820). Step S820 is a process in which betting bid data input by a first advertiser are recorded in corresponding record areas, and the rank of the betting bid data in the unit display zones is determined. In other words, step S820 is a bid processing process in which betting bid data with the first rank in each of unit display zones, among betting bid data of a first advertiser, are determined as valid bid data. In this process, the keyword advertisement display control system 200 aligns one or more pieces of bid data, which are recorded in the bid field 270, on the basis of the amount of fees for single click, and assigns a predetermined rank to each of the aligned bid data. The method for assigning the ranks, which are employed in the present embodiment, is a method in which the first rank is assigned to bid data with the highest fee per single click, among bid data recorded in the bid field 270, and the bid data with the first rank are determined as successful bid data. This bid process will be described in greater detail with reference to FIG. 9.

FIG. 9 is a flowchart illustrating an example of a method for performing a bid process for a unit display zone according to the present invention.

FIG. 9 illustrates a bid process performed, for example, in the bid processing means 240.

For a predetermined bid process, the keyword advertisement display control system 200 assigns a predetermined rank to each of bid data including betting bid data that are recorded in record areas associated with unit display zones (S910). Step S910 is a process of assigning each rank to each piece of bid data that are input into record areas associated with corresponding unit display zones, in order to determine a search listing that will be displayed in each of the unit display zones. For example, the first rank can be assigned to bid data with the highest fee per single click, and the lowest rank can be assigned to bid data with the lowest fee per single click.

The keyword advertisement display control system 200 then determines bid data, which have the highest rank, as successful bid data (S920). Step S920 is a process in which a display right is assigned to bid data with the first rank, and a search listing associated with the bid data with the first rank is displayed in a corresponding unit display zone. More particularly, in step S920, the keyword advertisement display control system 200 determines bid data (betting bid data), which are input by a first advertiser, as valid bid data when the bid data have the first rank in a corresponding unit display zone. For example, in FIG. 4, the keyword advertisement display control system 200 assigns the highest rank to betting bid data in unit display zone 1 301, unit display zone 2 302 and unit display zone 4 304, among betting bid data input by a first advertiser, and determines the betting bid data in these unit display zones as valid bid data.

Accordingly, the keyword advertisement display control system 200 displays a search listing associated with successful bid data in a first unit display zone. Therefore, there is an advantage in that the object of the present invention for performing an independent bid process in each of the unit display zones can be faithfully accomplished.

Referring again to FIG. 7, the keyword advertisement display control system 200 designates one piece of valid bid data, which is set by a bid selection of a first advertiser, and determines a unit display zone associated with the designated valid bid data as a first unit display zone (S750). Step S750 is a process in which a first unit display zone for which the first advertiser actually wants to participate in a bid is selected. In this process, as one piece of valid bid data is selected among one or more pieces of valid bid data, the unit display zone is designated as a first unit display zone (unit display zone 1 in FIG. 4). Accordingly, the intention of the first advertiser to preferentially display a search listing in a specific unit display zone is fully reflected. There is an advantage in that it is possible to prohibit inefficiency due to duplicate display of the same search listing on one screen when there are plural pieces of valid bid data of the first advertiser. At this time, betting bid data for which a bid selection is not made by the first advertiser are maintained in corresponding record areas, and can wait for an automatic re-bid (transfer a display right in a corresponding unit display zone to a different unit display zone, e.g., a second rank) or can be deleted from record areas.

The keyword advertisement display control system 200 assigns a display right in the determined first unit display zone to a search listing associated with the first advertiser (S760). Step S760 is a process of controlling a first search listing to be displayed in a first unit display zone for which a bid selection has been made. In this process, the first search listing is controlled to be displayed in the first unit display zone as search results of a search request.

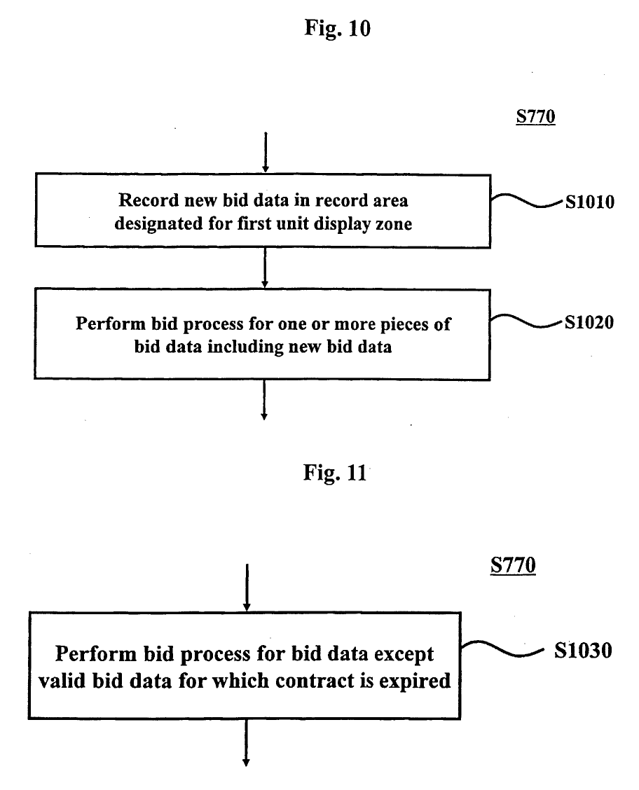

Referring again to FIG. 7, if a predetermined transfer condition is satisfied, the keyword advertisement display control system 200 controls the display right for the first search listing, which is associated with the advertiser in the first unit display zone, to be transferred to a predetermined second search listing that has participated in a bid for the first unit display zone (S760). Step S760 is a process in which if display of a first search listing is no longer allowed in the first unit display zone, the display right is transferred to a second search listing of the second highest bid data that waits for display or new bid data with a higher fee per single click. That is, the transfer condition in the present embodiment is the reception of new bid data or the expiration of a predetermined contract. The transfer of the display right to the second search listing will be described with reference to FIGS. 10 and 11.

FIG. 10 is a flowchart illustrating an example of a method for transferring a display right when new bid data are received as a transfer condition according to the present invention.

The keyword advertisement display control system 200 records new bid data, which are specially intended for a first unit display zone, in a corresponding record area (S1010). Step S1010 is a process in which bid data input for participation in a bid for the first unit display zone are received from a second advertiser and the received bid data are recorded in a record area of the bid field 270, which corresponds to the first unit display zone. The input of the new bid data can be performed without any time limitation. This can faithfully accomplish the object of the present invention for displaying predetermined search listings in real time after bid data have been input.

The keyword advertisement display control system 200 then performs a bid process for one or more pieces of bid data, including the new bid data, recorded in record areas (S1020). Step S1020 is a process of carrying out a bid process for record areas. If a fee per single click in the new bid data is higher than that of valid bid data that have already had a display right in the first unit display zone, the bid processing means 240 readjust a rank. That is, the bid processing means 240 deprives the valid bid data of the display right by assigning a second rank to them, whereas it transfers the display right to the new bid data by assigning the first rank to them and controls a relevant second search listing to be displayed in the first unit display zone. Accordingly, the transfer condition is satisfied, and the keyword advertisement display control system 200 performs an automatic re-bid for the first search listing, so that the first search listing can be successively displayed in a different unit display zone (second unit display zone).

FIG. 11 is a flowchart illustrating an example of a method for transferring a display right when a contract for display of a first search listing is expired as a transfer condition.

As shown in FIG. 11, the keyword advertisement display control system 200 performs a bid process for one or more pieces of bid data, which are recorded in a record area associated with a first unit display zone, except corresponding valid bid data on a first search listing for which a contract is expired (S1030). In this case, the expiration of the contract refers to a case where successive display of the first search listing with a display right (a right to display a search listing in a predetermined unit display zone) is disabled due to interruption of a keyword advertisement by an advertiser 130, exhaust of advertising deposits, or the like. That is, step S1030 is a process in which existing valid bid data (successful bid data) with the first rank of which a contract is expired are removed from a record area of the bid field 270, and a bid process is performed for bid data with a second or lower rank.

In the transfer condition that is the expiration of a contract, the display right is transferred to a second search listing included in bid data with the second highest rank within a corresponding unit display zone (preferably, first unit display zone). For example, the expiration of a contract can correspond to a case where a request for interruption of a keyword advertisement for a first search listing displayed in a first unit display zone is made by an advertiser or advertising deposits are exhausted. That is, if the transfer of the display right occurs, the keyword advertisement display control system 200 transfers the display right to bid data with the second highest rank, which have waited for display. Accordingly, the keyword advertisement display control system 200 transfers the display right to bid data with the second highest rank, and controls a relevant search listing to be displayed in the corresponding unit display zone. Further, the keyword advertisement display control system 200 performs an automatic re-bid for the first search listing if the transfer condition is satisfied, so that the first search listing is successively displayed in a different unit display zone (second unit display zone).

Therefore, according to the present invention, if a display right for a search listing that is being displayed is terminated, a search listing of bid data with the second highest rank that have waited for display is successively displayed in a corresponding unit display zone. Accordingly, there is an advantage in that an operator of the present system can obtain successive advertising profits.

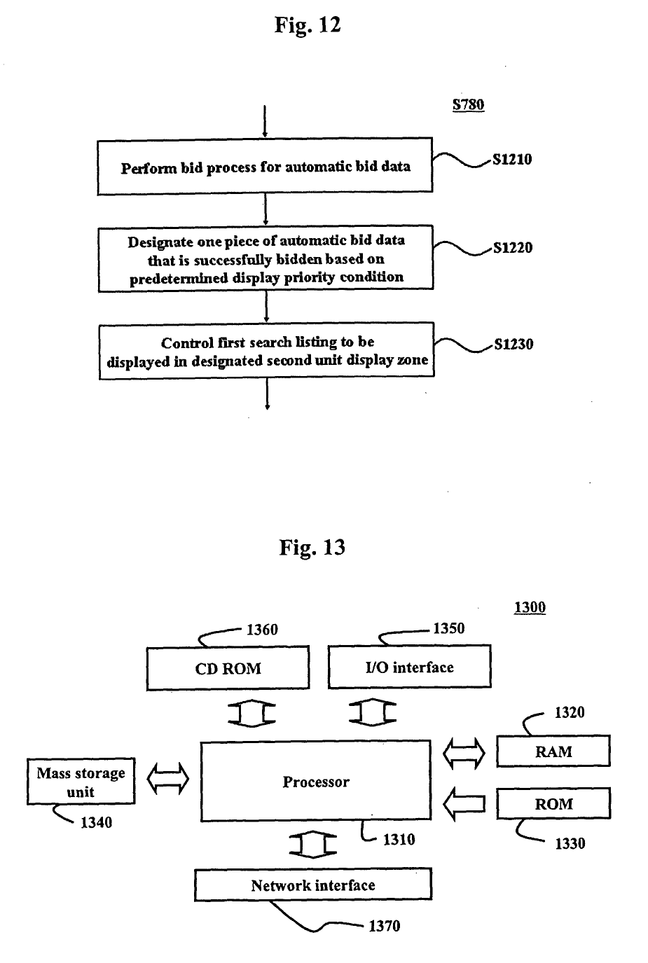

The keyword advertisement display control system 200 then performs a bid process again in association with display of the first search listing in the second unit display zone (S780). Step S780 is a process in which a bid process is performed for the remaining valid bid data except designated valid bid data, and for automatic bid data as betting bid data that are unsuccessful bidden. In this process, it is determined whether the first search listing can be displayed in a different unit display zone (second unit display zone) except the first unit display zone where the first search listing has been deprived of the display right. An automatic re-bid process for the first search listing will be described with reference to FIG. 12.

FIG. 12 is a flowchart illustrating an example of a method for performing an automatic re-bid process in association with display of a first search listing according to the present invention.

Here, a second unit display zone refers to a unit display zone into which betting bid data are input, except a first unit display zone.

The keyword advertisement display control system 200 controls a bid process to be performed for automatic bid data (S1210). Step S1210 is a process in which a re-bid process is performed for betting bid data, which have been unsuccessfully bidden in an initial bid process, or valid bid data for which a bid selection has not been made. For example, in FIG. 5, the automatic re-bid process is performed for betting bid data that have been input corresponding to unit display zone 2 302 to unit display zone 4 304. That is, in this step S1210, it is determined whether the first search listing, which has been deprived of the display right in the first unit display zone, can be displayed in a different unit display zone (second unit display zone).

The keyword advertisement display control system 200 specially designates one piece of automatic bid data based on a predetermined display priority condition when at least some pieces of automatic bid data are successfully bidden through the automatic re-bid process (S1220). Step S1220 is a process of determining a single second unit display zone where the first search listing will be displayed in a case where one piece of automatic bid data is to be arranged at the top (first rank) in two or more second unit display zones through the automatic re-bid. For example, in FIG. 5, second unit display zones in which automatic bid data are successfully bidden through the automatic re-bid are unit display zone 2 302 and unit display zone 4 304. The keyword advertisement display control system 200 specially designates automatic bid data that have participated in a bid for unit display zone 2 302 or unit display zone 4 304 under the display priority condition.

The display priority condition can include an arrangement order of second unit display zones associated with automatic bid data that are successfully bidden, the amount of fee per single click in automatic bid data that are successfully bidden, and selection of the automatic bid data that are successfully bidden by an advertiser. A detailed description thereof will be replaced with that of the automatic re-bid of the aforementioned bid processing means 240 and thus omitted. According to the present invention, an additional bid chance is given through an automatic re-bid so that a first search listing, which has been deprived of a display right in a first unit display zone, can be successively displayed on a search screen. Accordingly, there is an advantage in that a first advertiser can obtain stable advertising effects.

Further, the keyword advertisement display control system 200 controls the first search listing to be displayed in a second unit display zone for which the specially designated automatic bid data have participated in a bid (S1230). Step S1230 is a process of successively displaying the first search listing in a designated second unit display zone. With this process, the first search listing can be displayed at a new display location (in a second unit display zone) in response to a keyword search of the searcher 120, instead of the first search listing being displayed in the previous first unit display zone where the first search listing has been deprived of the display right.

Thus, according to the present invention, a search listing is displayed only at a display location desired by the advertiser 130 and is not displayed at other display locations. Accordingly, there is an advantage in that an active selection of a display location by the advertiser 130 can be guaranteed. Further, even though a search listing cannot be displayed at a desired display location, it can be displayed at one of other display locations through an automatic re-bid. Therefore, there is an advantage in that successive advertising effects can be obtained.

The embodiments of the present invention include a computer-readable medium having a program with instructions for performing operations implemented by a variety of computers. The computer-readable medium can include instructions of a program, a data file, a data structure or the like, or a combination thereof. The medium can be specially designed or constructed to be adapted to the present invention, or can be one known to those skilled in the field of computer software. Examples of the computer-readable recording medium can include hardware devices, which are specially designed to store and perform instructions of a program, including magnetic media such as a hard disk, a floppy disk and a magnetic tape, optical recording media such as a CD-ROM and a DVD, a magnetic-optical media such as a floptical disk, a ROM (Read Only Memory), a RAM (Random Access Memory) and a flash memory. The medium can be a transmission medium, such as an optical or metal line or a waveguide, which transmits carrier waves including signals for specifying instructions of a program, a data structure and the like. An example of instructions of a program can include a high-level language code that can be executed by a computer using an interpreter or the like as well as a machine code such as a code prepared by a complier.

FIG. 13 is a block diagram showing the inner configuration of a general-purpose computer system that can be employed in performing the method for controlling a keyword advertisement according to the present invention.

The computer system 1300 comprises one or more processors 1310 connected to a main storage unit having a RAM 1320 and a ROM 1330. The processor 1310 is also called “central processing unit (CPU)”. As well known in the art, the ROM 1330 serves to unidirectionally transmit data and instructions to the CPU. The RAM 1320 is generally used to bidirectionally transmit data and instructions. The RAM 1320 and the ROM 1330 can include any proper type of computer-readable medium. A mass storage unit 1340 is connected bidirectionally to the processor 1310 and provides additional data storage capability. The mass storage unit 1340 can be any one of the aforementioned computer-readable recording media. The mass storage unit 1340 is used to store programs, data and the like and is an auxiliary storage unit, such as a hard disk, which generally has a speed slower than that of the main storage unit. A specific mass storage unit such as a CD-ROM 1360 can be used. The processor 1310 is connected to one or more I/O interfaces 1350, such as a video monitor, a trackball, a mouse, a keyboard, a microphone, a touch screen type display, a card reader, a magnetic or paper tape reader, an audio or handwriting recognizer, a joystick, or other known computer I/O devices. Finally, the processor 1310 can be connected to a wired or wireless communication network through a network interface 1370, and can perform the processes of the aforementioned method through such network connection. The aforementioned devices and equipment are well known to those skilled in the field of computer hardware and software.

The aforementioned hardware devices can be configured to operate as one or more software modules in order to perform the operations of the present invention.

Although the present invention has been described in connection with the specific embodiments of the present invention, it will be apparent that various modifications and changes can be made thereto without departing from the scope of the present invention.

Thus, the scope of the present invention should not be limited and defined by the embodiments but should be defined by the appended claims and equivalents thereof.

Although the present invention has been described and illustrated in connection with the specific embodiments and the accompanying drawings, it is not limited thereto but can be variously modified and changed by those skilled in the art from the description herein. Therefore, the spirit of the present invention should be understood only based on the appended claims, and equivalents thereof will fall within the scope and spirit of the present invention.

### INDUSTRIAL APPLICABILITY

As described above, according to the present invention, there is provided a method for controlling a keyword advertisement and a system thereof, wherein even though a right to display a search listing at a predetermined display location is lost under a predetermined condition, the display of the corresponding search listing continues through an automatic bid process allowing the search listing to be displayed at a different display location.

Further, according to the present invention, there is provided a method for controlling a keyword advertisement and a system thereof, wherein advertising effects desired by an advertiser can be obtained in such a manner that a search listing as search results is displayed at a display location desired by the advertiser through input of a bid price and a predetermined bid process.

Moreover, according to the present invention, there is provided a method for controlling a keyword advertisement and a system thereof, wherein display of a search listing at a specific display location is selected through a bid, and a search listing can be displayed in real time without a bid waiting period through input of proper bid data.

In addition, according to the present invention, there is provided a method for controlling a keyword advertisement and a system thereof, wherein a rational bid process is performed in such a manner that the highest fee per single click, which is payable by each advertiser, is included in bid data submitted by the advertiser and successful bid data are selected through comparison of the fees for a single click.

What is claimed is:

1. A computer-implemented method for controlling display of a keyword advertisement, comprising the steps of:
(a) defining a plurality of advertisement locations for placement of advertisements in association with keywords, at least one of said advertisement locations including a plurality of unit display zones in association with a predetermined keyword;
(b) receiving at least one bid data corresponding to a first unit display zone from at least one advertiser, said first unit display zone being one of the plurality of said unit display zones associated with said predetermined keyword;
(c) storing said bid data;
(d) determining whether a predetermined transfer condition for right to display said first unit display zone is satisfied, which a first advertiser owns;
(e) retrieving at least a portion of said stored bid data; and
(f) determining winning bid among said retrieved bid data for placement of advertisement on said first unit display zone in association with search result list generated in response to a search query associated with said predetermined keyword; and
(g) transferring said display right of said first unit display zone from said first advertiser to a second advertiser which has submitted said winning bid.

2. The method as claimed in claim 1, further comprising the step of:
if said display right of said first unit display zone is transferred to said second advertiser, the steps (d)˜(g) are executed for at least one of the remaining unit display zones associated with said predetermined keyword.

3. The method as claimed in claim 1, wherein, if said second advertiser has submitted a plurality of winning bids corresponding to a plurality of said unit display zones associated with said predetermined keyword, one unit display zone is assigned to said second advertiser in accordance with at least one predetermined display priority condition.

4. The method as claimed in claim 3, wherein the predetermined display priority condition is determined based at least in part on review of cost-per-click pricing model.

5. The method as claimed in claim 1, wherein said bid data include payable fee per single click, and
the step (f) of determining winning bid comprises the step of:
determining winning bid in accordance with said payable fee per single click.

6. The method as claimed in claim 1, further comprising the step of ordering said stored bid data in accordance with payable fee per single click, said payable fee per single click being included in said bid data, wherein the step (f) of determining winning bid determines said winning bid in accordance with the order of said bid data.

7. The method as claimed in claim 1, wherein the predetermined transfer condition is associated with a bid data corresponding to the first unit display zone, which has been newly submitted, and
the step (f) of determining winning bid comprises the steps of:
ordering said stored bid data;
reordering said stored bid data if a new bid data has been submitted; and
determining winning bid in accordance with the order of said bid data.

8. The method as claimed in claim 1, wherein the predetermined transfer condition is associated with the expiration of a predetermined contract for the search listing.

9. (canceled)

10. A computer-implemented method for controlling display of a keyword advertisement in association with a search results list, wherein the search results list is generated in response to a search query, comprising the steps of:
(a) receiving a plurality of bids for a particular placement position of advertisement in association with a predetermined keyword, said each bid indicating a bid amount and an advertisement;
(b) storing said bids;
(c) determining whether a predetermined transfer condition for right to display said particular placement position of advertisement is satisfied, which has been assigned to a first advertiser;
(d) selecting, based at least in part on review of bid amounts, a bid of said stored bids for said particular placement position of advertisement in association with said predetermined keyword; and
(e) transferring said right to display said particular placement position of advertisement in association with said predetermined keyword from said first advertiser to a second advertiser who has submitted said selected bid.

11. (canceled)

12. The method as claimed in claim 10, wherein if said second advertiser wins bidding for more than one placement position of advertisement in association with said predetermined keyword, one placement position of advertisement in association with said predetermined keyword is assigned to said second advertiser in accordance with a predetermined condition, and wherein said predetermined condition is determined based at least in part on review of cost-per-click pricing model.

13. A computer-readable recording medium having computer-executable instructions for executing a method according to claim 1.

14. A keyword advertisement display control system, comprising:
means for defining a plurality of advertisement locations in association with a plurality of keywords, at least one of said advertisement locations including a plurality of unit display zones in association with a predetermined keyword;
a user interface, said user interface receiving bid data corresponding to a first unit display zone of the plurality of unit display zones associated with the predetermined keyword from at least one advertiser;
a memory, said memory storing said bid data;
means for processing bid for said first unit display zone, said means for processing the bid determining winning bid for said first unit display zone; and
means for transferring a display right of said first unit display zone to an advertiser who has submitted the winning bid,
wherein said means for processing the bid performs a re-bid process if a predetermined transfer condition for the display right of said first unit display zone is satisfied.

15. The method as claimed in claim 3, wherein the predetermined display priority condition is determined based at least in part on review of selection by said second advertiser.

16. The method as claimed in claim 10, wherein if said second advertiser wins bidding for more than one placement position of advertisement in association with said predetermined keyword, only one placement position of advertisement in association with said predetermined keyword is assigned to said second advertiser in accordance with a predetermined condition, and wherein said predetermined condition is determined based at least in part on review of selection by said second advertiser.

17. A computer programmed to perform the steps recited in claim 1.

18. A computer programmed to perform the steps recited in claim 10.

19. A computer-readable medium having computer-executable instructions embodied thereon for controlling display of a keyword advertisement, comprising:
code for defining a plurality of advertisement locations for placement of advertisements in association with keywords, at least one of said advertisement locations including a plurality of unit display zones in association with a predetermined keyword;
code for receiving at least one bid data corresponding to a first unit display zone from at least one advertiser, said first unit display zone being one of the plurality of said unit display zones associated with said predetermined keyword;
code for storing said bid data;
code for determining whether a predetermined transfer condition for right to display said first unit display zone is satisfied, which a first advertiser owns;
code for retrieving at least a portion of said stored bid data
code for determining winning bid among said retrieved bid data for placement of advertisement on said first unit display zone in association with search result list generated in response to a search query associated with said predetermined keyword; and
code for transferring said display right of said first unit display zone from said first advertiser to a second advertiser which has submitted said winning bid.

20. A computer-readable medium having computer-executable instructions embodied thereon for controlling display of a keyword advertisement in association with a search results list, wherein the search results list is generated in response to a search query, comprising:
code for receiving a plurality of bids for a particular placement position of advertisement in association with a predetermined keyword, said each bid indicating a bid amount and an advertisement;
code for storing said bids;
code for determining whether a predetermined transfer condition for right to display said particular placement position of advertisement is satisfied, which has been assigned to a first advertiser;
code for selecting, based at least in part on review of bid amounts, a bid of said stored bids for said particular placement position of advertisement in association with said predetermined keyword; and
code for transferring said right to display said particular placement position of advertisement in association with said predetermined keyword from said first advertiser to a second advertiser who has submitted said selected bid.
